(19) United States
(12) Patent Application Publication
(10) Pub. No.: US 2012/0276954 A1
(43) Pub. Date: Nov. 1, 2012

(54) PORTABLE CAMERA AND SURVEILLANCE DEVICE

(76) Inventor: JERRY KOWALSKY, Irvine, CA (US)

(21) Appl. No.: 13/543,579

(22) Filed: Jul. 6, 2012

Related U.S. Application Data
(63) Continuation-in-part of application No. 12/432,459, filed on Apr. 29, 2009.

(51) Int. Cl. H04W 88/02; G06F 3/041

(52) U.S. Cl. 455/556.2

(57) ABSTRACT

The invention is a portable camera and surveillance device adapted to attach to a plurality of distinct support structures and transmit an image signal. More particularly, an apparatus that includes the use of a wireless mobile device paired to a camera surveillance device through an ad-hoc peer-to-peer connection for surveillance purposes. Once paired, the wireless mobile device can operate the use of a surveillance application software for further surveillance tactical actions in conjunction with camera surveillance device.

### PRIORITY NOTICE

This application is a continuation-in-part application that claims priority under 35 U.S.C. §120 to U.S. patent application Ser. No. 12/432,459 filed on Apr. 29, 2009, the disclosure of which is incorporated herein by reference in its entirety.

### TECHNICAL FIELD OF THE INVENTION

The present invention relates in general to a portable camera and surveillance device, and more specifically, to a portable camera adapted to attach to a plurality of distinct support structures and transmit an image signal. The present invention also includes the use of a wireless mobile device paired to a camera surveillance device through an ad-hoc peer-to-peer connection for surveillance purposes. Once paired to the camera surveillance device, the wireless mobile device can operate the use of surveillance application software for further surveillance tactical actions in conjunction with camera surveillance device.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

Law enforcement personnel rely upon their senses in order to perform their jobs. What an officer can see, hear, and smell play critical roles in their decision-making ability. As such, law enforcement agencies regularly embrace technology, as new technology that enables the collection of more accurate information allows an officer to make faster, safer and better informed decisions.

Because safety is one of the primary concerns for law enforcement personnel, the utilization of video surveillance equipment in potentially dangerous or hostile situations allows law enforcement personnel to see what they are up against. Without surveillance equipment, law enforcement officers frequently encounter situations wherein line of sight of a desired person, location or object can only be retrieved from a position that may be inaccessible, inconvenient, or unsafe. Thus, there is a need for surveillance devices that provide video access to viewpoints that would be traditionally inaccessible, inconvenient, or unsafe.

Video/audio surveillance equipment, in conjunction with communications equipment, further allows for better coordination between law enforcement officers and other personnel. Better coordination and communication will lead to more intelligent decision-making, which likely yields increases in safety and deceases in error. Because law enforcement personnel frequently encounter situations wherein they are unable to describe what they observe, there is a need for surveillance equipment that allows for better coordination between law enforcement officers.

Law enforcement personnel, while they would like to embrace the most technologically advanced equipment possible, are frequently restricted by high cost. Therefore, surveillance equipment that is multi-functional provides higher cost effectiveness when used by a law enforcement agency. Additionally, multi-functional equipment allows for an officer to carry less equipment, thus easing their equipment burden in the field. As such, there is a need for surveillance equipment that is either low cost or multi-functional.

Another concern experienced by law enforcement agencies is the ability to be able to utilize a sound and secure network infrastructure for equipment used in tactical and surveillance operations. Additionally, law and military enforcement agencies and personnel often have to rely on expensive and costly network/technology units that are monetarily supported by the relevant law or military departments, and other related entities.

Other times, law or military personnel may have to rely upon the surrounding networks, including those pertaining to Internet, local area networks and cellular networks, for use of their tactical/surveillance equipment. Not only may these networks be insecure or require a cost for access, but they may compromise the integrity of the mission and even hinder the ability of the law or military personnel to be self-sufficient in the field. This can increase the cost of conducting tactical and surveillance actions as well as make it less feasible for carrying out missions in any type of location or environment. Accordingly, there is also a need for a more secure as well as self-reliant network infrastructure for surveillance actions.

Also of concern to various law and military personnel are the costs for sustaining an adequate level of current and cost-effective tactical and surveillance equipment. With rapidly developing technological advances, law and military departments must continually expend resources to keep up to date with the technologies needed for tactical and surveillance needs. Technological advances in surveillance techniques can greatly affect the abilities of law and military personnel to perform their duties better and more efficiently. Thus, the balance between updating technology advances and maintaining costs can be of great concern in deciding how to allocate budgeting and equipment resources. Accordingly, there is a need for providing law and military personnel with up-to-date tactical and surveillance resources while maintaining or even decreasing the associated costs for doing so.

Thus, there is a need in the art for a portable camera and surveillance device. Specifically, there is a need for a portable camera that is multi-functional, allows for coordination between officers and provides remote sight access to traditionally inaccessible or dangerous viewpoints. It is to these ends that the present invention has been developed.

### SUMMARY OF THE INVENTION

To minimize the limitations in the prior art, and to minimize other limitations that will be apparent upon reading and understanding the present specification, the present invention describes a smartphone device, comprising: a transceiver; a touch-screen display; and a processor configured to: generate an icon on the touch-screen display; in response to a user initiation on the touch-screen display associated with the icon, provide on the touch-screen display a plurality of icons representing functions; in response to the user actuation of a first function of the plurality of functions, sending a command to a paired camera via the transceiver requesting video data from the paired camera and recover video data from the paired camera via the transceiver; and generate an image on the touch-screen display based on the video data.

The present invention further describes a smartphone device, comprising: a first transceiver; a touch-screen display; a processor; and an external paired display device, which further comprises a second transceiver; wherein the processor is configured to: generate an icon on the touch-screen display; in response to a user initiation on the touch-screen display associated with the icon, provide on the touch-screen display a plurality of icons representing functions; in response to the user actuation of a first function of the plurality of functions, send a command to a paired camera via the first transceiver requesting video data from the paired camera; in response to the command requesting video data, the paired camera sends video data via the second transceiver and generates an image on the externally paired display device based on the video data.

The present invention further describes a smartphone device, comprising: a transceiver; a touch-screen display; and a processor configured to: generate an icon on the touch-screen display; in response to a user initiation on the touch-screen display associated with the icon, provide on the touch-screen display a plurality of icons representing functions; in response to the user actuation of a first function of the plurality of functions, send a command to a plurality of paired cameras via the transceiver requesting video data from the plurality of paired cameras and recover video data from the plurality of paired cameras via the transceiver; and generate one or more images on the touch-screen display based on the video data from the plurality of paired cameras..

It is an objective of the present invention to provide a portable camera that may be securely attached to a plurality of distinct support structures.

It is another objective of the present invention to provide a user safe and convenient visual access to areas traditionally inaccessible, inconvenient, or unsafe.

It is yet another objective of the present invention to provide law enforcement officers with a lightweight, portable surveillance device.

It is yet another objective of the present invention to provide a user with images from a plurality of portable cameras.

Further, it is an objective of the present invention to provide a user with a cost-effective surveillance system for active surveillance techniques utilizing a user's personal or department wireless mobile device with, for example, ad-hoc WiFi and Bluetooth connection abilities.

It is also an objective of the present invention to provide a user with a secure, self-sufficient surveillance system through the establishment of an ad-hoc peer-to-peer connection between a user's wireless mobile device and a camera surveillance device.

It is also an objective of the present invention to provide a user with various surveillance techniques via surveillance application software for use on the user's wireless mobile device.

Yet further, it is an objective of the present invention to provide a user with live visual and audio feed from a camera surveillance device via the user's wireless mobile device enabled with the surveillance application software.

Lastly, it is an objective of the present invention to provide a user with a self-sufficient camera surveillance device with a removable energy resource that allows lower costs, higher efficiency as well as consistency in use.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) is a simplified illustration of a left side elevational view of the interior components of an exemplary embodiment of the present invention.

FIG. 1(b) illustrates a simplified illustration of a rear perspective view of an exemplary embodiment of the present invention.

FIG. 2 illustrates exemplary use of a portable camera surveillance device in accordance with the present invention.

FIG. 3(a) illustrates a side view of an exemplary embodiment of a law enforcement aid.

FIG. 3(b) illustrates a side view of another exemplary embodiment of a law enforcement aid.

FIG. 4 illustrates a perspective view of an exemplary embodiment of a law enforcement aid.

FIG. 5(a) illustrates an overhead view of exemplary use of a camera surveillance system.

FIG. 5(b) illustrates a front elevational view of a portable receiver in a camera surveillance system.

FIG. 5(c) illustrates a user interface home-screen of a wireless mobile device depicting a application software icon for law and military surveillance that may be paired with one or more camera surveillance devices.

FIG. 5(d) illustrates an example of a screen-only view depicting the live video feed from the camera surveillance device as well as a settings menu showing a set of exemplary features and functions of the wireless application.

FIG. 5(e) illustrates an exploded-view of the internal settings for certain of the application features and functions previously illustrated in FIG. 5(d).

FIG. 5(f) illustrates an example of a live video viewing screen depicting a multi-video screen viewing mode of four camera surveillance devices that may be paired to the wireless mobile device.

### DETAILED DESCRIPTION OF THE DRAWINGS

In the following discussion that addresses a number of embodiments and applications of the present invention, reference is made to the accompanying drawings that form a part hereof, where depictions are made, by way of illustration, of specific embodiments in which the invention may be practiced. It is to be understood that other embodiments may be utilized and changes may be made without departing from the scope of the present invention.

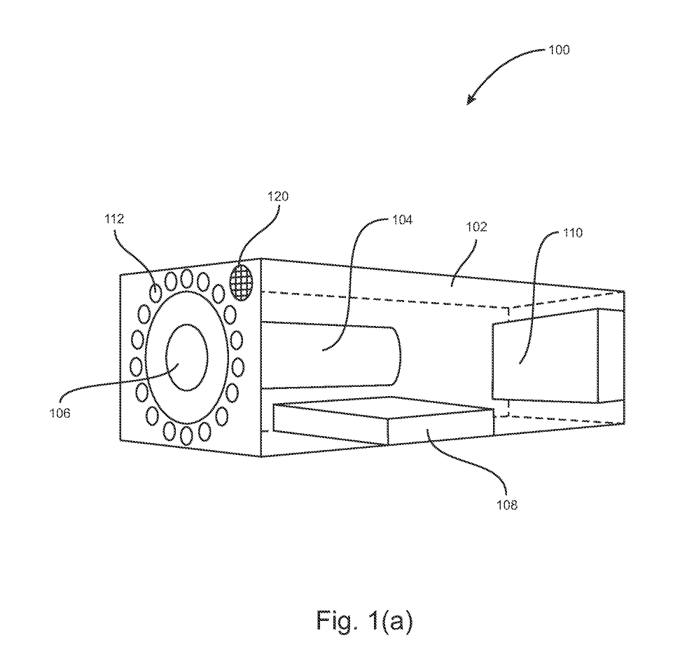

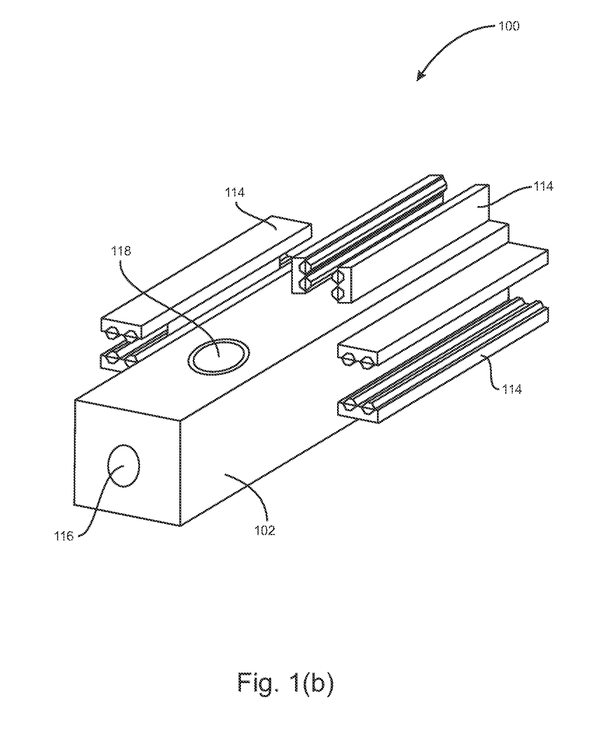

FIG. 1(a) is a simplified illustration of a left side elevational view of the interior components of an exemplary embodiment of the present invention. FIG. 1(b) illustrates a simplified illustration of a rear perspective view of an exemplary embodiment of the present invention.

FIGS. 1(a) and 1(b) show portable camera 100, comprising housing 102, camera 104, lens 106, transmitter 108, power source 110, lighting 112, universal connecter 114, secondary connecter 116, power switch 118, and audio recording component 120. Portable camera 100 is designed to transmit still or video images generated by camera 104 through lens 106, as well as the corresponding audio feedback generated by audio recording component 120, but to also allow for the secure attachment and removal of portable camera 100 to a plurality of distinct support structures, enabling a user to combine a variety of components to achieve the functionality of single purpose equipment.

Housing 102 is the main body of portable camera 100. Housing 102 is an object designed to be easily and securely attached to and removed from a plurality of distinct support structures, such as the end of a pole, on the front of a helmet, or on a surface or other portion of a weapon. In an exemplary embodiment, housing 102 may couple to a plurality of distinct support structures, but to also allow for image generation and transmission when portable camera 100 is in use. In an exemplary embodiment, housing 102 may be rectangular in shape; however, in other embodiments, housing 102 may be cylindrical, conical, cubical, or other shape configuration.

Housing 102 may be composed of a variety of materials, such as metals, plastics, or alloys. This list is not exhaustive, however, and should not be interpreted so as to limit the scope of the present invention. In an exemplary embodiment, the material used in the composition of housing 102 may be rigid so as to maintain a pre-molded shape, but to also be sufficiently lightweight and durable to withstand frequent use. Further, housing 102 may absorb or dampen the force of sudden movement, thereby protecting portable camera 100's interior components for image generation and transmission. Additionally, housing 102 may also be composed of a material able to shield portable camera 100's interior components from damage by heat radiated by an exterior source.

Camera 104 is a component of portable camera 100 situated within housing 102. Camera 104 is designed to generate or capture still or moving images illustrative of a portion of the electromagnetic spectrum that enters portable camera 100 via lens 106. Lens 106 is a component of camera 104 located in front of camera 104's opening, planar to housing 102. In an exemplary embodiment, lens 106 may gather light and focus it for processing. Additionally, camera 104 may be fixed focus, or have auto focus or rangefinder capabilities. In an exemplary embodiment, camera 104 may function through digital means; however, camera 106 may capture images through analog technology.

In an exemplary embodiment, camera 104 may generate images of the visible portion of the electromagnetic spectrum. However, in another embodiment, camera 104 may generate images of the infrared, or another portion of the electromagnetic spectrum. As such, camera 104 may capture images through a range of luminosity. In an exemplary embodiment, camera 104 may capture images in the infrared portion of the electromagnetic spectrum, which may be useful in situations with low levels of visible light (e.g. night-vision). Further, camera 104 may generate images in color, black and white, or other types of image output.

Audio recording component 120, which is part of portable camera 100, may be situated proximate to lens 106 and lighting 112 of housing 102. Audio recording component 120 is designed to record audio feedback received concurrent with the still or moving images recorded by camera 104. In one embodiment, audio recording component 120 is a microphone adapted to record audio feedback. In another embodiment, audio recording component 120 may record audio feedback by means of analog or digital recordings without limiting the scope of the present invention.

Transmitter 108 is a component of portable camera 100 designed to transmit images generated by camera 104. Transmitter 108 may be located within housing 102, or in another embodiment, may be external to housing 102. Transmitter 108 is connected to camera 104 such that transmitter 108 may transmit images generated by camera 104. In an exemplary embodiment, transmitter 108 may transmit on the industrial, scientific, and medical radio (ISM) bands. However, transmitter 108 may be configured to transmit on a wide number of other electromagnetic frequencies. Further, transmitter 108 may be configured to wirelessly interface directly with a remote device, i.e. Bluetooth protocol, or may be configured to transmit utilizing a wireless network protocol.

Power source 110 supplies portable camera 100 with power. Power source 110 may be contained within housing 102. Power source 110 may comprise a battery. In an exemplary embodiment, power source 110 may be rechargeable. In such an embodiment, power source 110 may include a charging port, or other connection type interface for recharging. In an alternative embodiment, power source 110 may be removable, such that power source 110 is removed from portable camera 100 for recharging. In yet another embodiment, power source 110 may be disposable, such that power source 110 may be replaced when its charge has been depleted. Power source 110 may be connected to camera 104 and transmitter 108.

Lighting 112 is a component of portable camera 100. Lighting 112 is a light source that emits energy in the visible portion of the electromagnetic spectrum. In an exemplary embodiment, lighting 112 may contain a light emitting diode; however, lighting 112 may emit light by way of a filament, and the method of light emission should not limit the scope of the present invention. Portable camera 100, however, need not include lighting 112.

In the present embodiment of portable camera 100, which includes lighting 112, lighting 112 may provide a light source for camera 104 in environments with low relatively levels of light. In an exemplary embodiment, lighting 112 may be contained within housing 102, with the light emitter planar to housing 102. Alternatively, lighting 112 may be situated external to housing 102. Preferably, lighting 112 may be powered by power source 110.

Universal connecter 114 is a component of portable camera 100 that is designed to couple with a plurality of distinct support structures. In an exemplary embodiment, portable camera 100 may contain a plurality of universal connectors 114, each located on a different surface of housing 102. Universal connector 114 is coupled to housing 102 such that portable camera 100 may be removably attached to an external support structure via universal connector 114. Universal connector 114 may comprise a picatinny rail mount, or another standardized mount type specification so as to be compatible with a plurality of connection devices.

In an exemplary embodiment of the present invention, universal connector 114 may comprise a first rail adapted to slide upon a corresponding second rail on an external support structure, with a locking mechanism to securely attach the first and second rails together. In an exemplary embodiment, the locking mechanism of universal connector 114 may be engaged or disengaged by a user, such that portable camera 100 may be securely attached and removed from the distinct support structure. In the present invention, the locking mechanism of universal connector 114 may be engaged by sliding a first rail and a second rail together, until the locking mechanism clicks into place. The locking mechanism of universal connector 114 may be disengaged mechanically, whereby a user may press or push a latch, disengaging the lock and allowing the user to slide the first rail off of the second rail. In other embodiments, however, the locking mechanism of universal connector 114 may function by electrical or other type of method, and thus the method of locking of universal connector 114 should not be interpreted so as to limit the present invention.

Universal connector 114 may be composed of a variety of materials, such as metals, plastics, or alloys. This list is not exhaustive, however, and should not be interpreted so as to limit the scope of the present invention. In an exemplary embodiment, universal connector 114 may be composed of a material so as to be sufficiently rigid to maintain portable camera 100's connection to the support device, durable to withstand frequent use, and able to absorb or dampen the force of sudden movement. Additionally, universal connector 114 may also be composed of a material able to withstand heat radiated by an exterior source, such as a support structure.

Secondary connecter 116 provides an alternative means connection for portable camera 100 to couple with a plurality of distinct support structures. Secondary connector 116 may be situated upon housing 102. In the present embodiment, secondary connector 116 is composed of a male and female screw-type configuration. Alternatively, secondary connector 116 may comprise some other type of connection method. As such, the type of connection utilized by secondary connector 116 should not be interpreted so as to limit the scope of the present invention.

Power switch 118 is a component of portable camera 100. Power switch 118 designed to allow the user to turn on and off the components of portable camera 100. In an exemplary embodiment, power switch 118 may comprise a switch, knob, compressible button, or some other type of component such as to provide the user a means of switching portable camera 100 on and off. In exemplary usage of portable camera 100, activating power switch 118 while portable camera 100 is in an off state would turn portable camera 100 on, while activating power switch 118 while portable camera 100 is in an on state would turn portable camera 100 off.

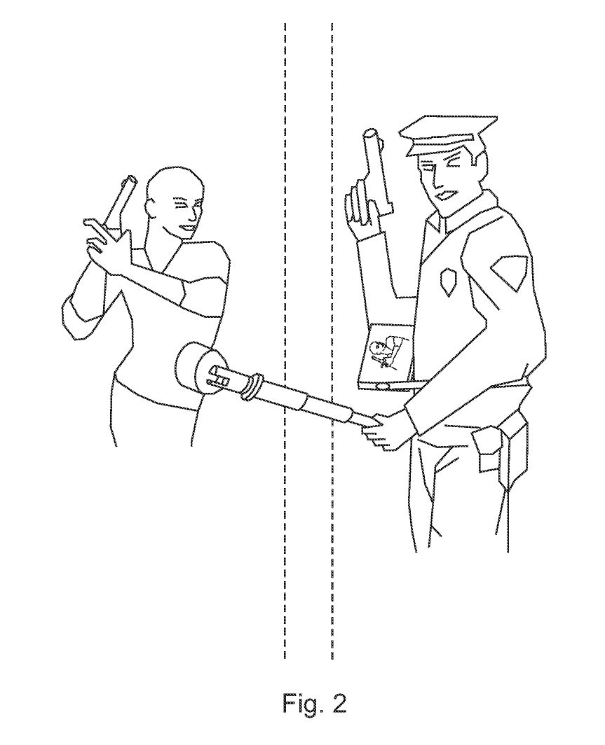

FIG. 2 illustrates exemplary use of a portable camera surveillance device in accordance with the present invention. As illustrated in FIG. 2, exemplary use of the present invention may include using a portable camera surveillance device to capture and transmit visual images around an obstacle. In the present illustration, a police officer is using a law enforcement aid, to be described in detail below, to transmit images around a barrier, such as a wall or door frame. By using the law enforcement aid, in conjunction with a portable receiver display, the officer is able to assess in real time the situation on the other side of the barrier. Alternatively, the present invention may be utilized by a plurality of law enforcement officers, wherein one officer uses portable camera surveillance device to capture and transmit images around an obstacle, while another officer uses portable receiver display in order to assess in real time the situation on the other side of the barrier. Additionally, alternative examples of usage of the present invention may include use of a law enforcement aid to transmit images to a remote receiver.

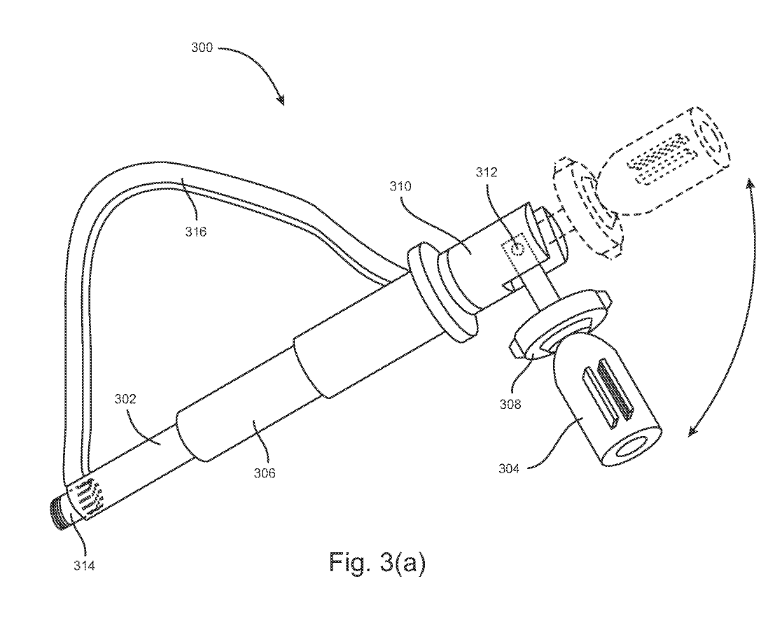

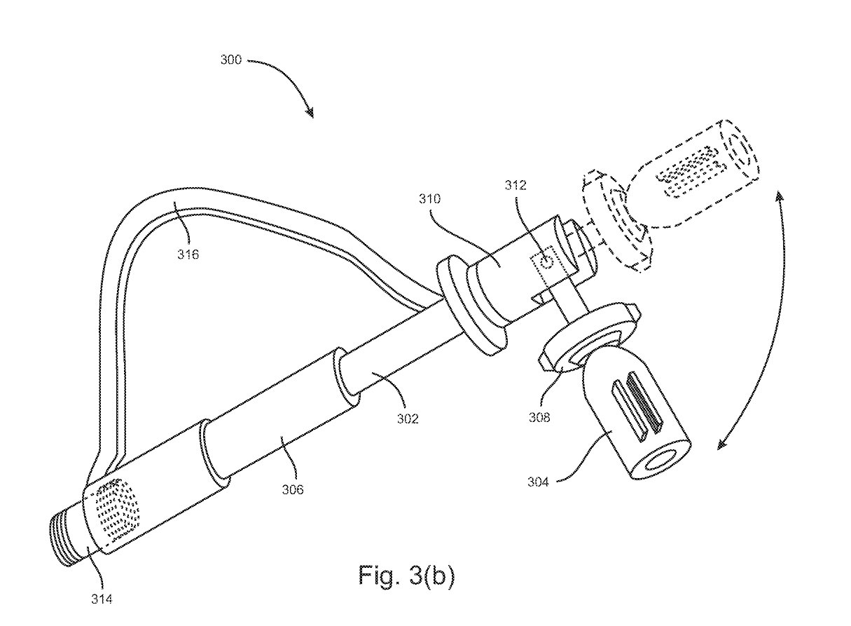

FIG. 3(a) illustrates a side view of an exemplary embodiment of a law enforcement aid. FIG. 3(b) illustrates a side view of another exemplary embodiment of a law enforcement aid. FIGS. 3(a) and 3(b) show law enforcement aid 300, comprising pole 302, portable camera 304, pole joint 306, pole mount 308, rotator 310, intermediary device 312, pole extender 314, and shoulder sling 316. Law enforcement aid 300 is designed to allow a user to capture and transmit images through portable camera 304, which may be extended and retracted at the end of pole 302.

Pole 302 is the main body of law enforcement aid 300. Pole 302 is an object designed to be extended or retracted in length. In an exemplary embodiment, pole 302 may have a telescopic structure, wherein pole 302 may comprise a plurality of nesting telescopic pole joints 306. Pole joints 306 may be extended to elongate pole 302, or retracted to shorten pole 302. In the embodiment of law enforcement aid 300 depicted in FIG. 3(a), the cross-section of each pole joint 306 may increase in size from a distal end of pole joint 306 to the proximal end of pole joint 306 at rotator 310, with the cross-section of each nested pole joint 306 being sequentially smaller than the pole joint 306 it is nested within along the length of pole 302. In the embodiment of law enforcement aid 300 depicted FIG. 3(b), however, the cross-section of each pole joint 306 may decrease in size from a distal end of pole joint 306 at rotator 310 to the proximal end of pole joint 306. As such, each pole joint 306 may slide upon the other, but pole joints 306 may not be removed from pole 302. Alternative embodiments of law enforcement aid 300, however, may include other means for extension and retraction of pole 302, such as parallel connected extendable members, screw-rotation motion, air or pneumatic expansion or retraction, or some type of material based elasticity. Therefore, the telescopic nature of pole 302 should not be interpreted so as to limit the scope of the present invention.

Preferably, pole joints 306 may be rigid such that pole 302 may only extend and retract in length, and may not flex in any other direction. However, in alternative embodiments of law enforcement aid 300, pole joints 306 may flex or bend. In such embodiments of the present invention, pole 302 may be extended in a plurality of directions, allowing for extension and retraction of pole 302 around corners or potential obstacles that would stand in the way of one dimensional extension and retraction.

The maximum and minimum length of pole 302 may be modified by attaching or removing pole joints 306 via pole extender 314. Pole extender 314 is a component of law enforcement aid 300 that may couple one pole joint 306 to another pole joint 306. In an exemplary embodiment of the present invention, pole extenders 314 may be located at a distal and proximal ends of pole joint 306. Further, pole extender 314 at a distal end of pole joint 306 may comprise a male screw-type configuration, and pole extender 314 at a proximal end of pole joint 306 may comprise a female screw-type configuration. Additionally, pole extender 316 may comprise a universal rail mount connection to couple pole joints 306, or other connection methods.

In exemplary usage of law enforcement aid 300, a user may extend the length of pole 302 by applying an outward longitudinal force along the length of pole 302, thereby pulling or sliding pole joints 306 out from a nestled position. As pole joints 306 are pulled away from a nestled position, pole 302 extends and the length of pole 302 may increase. When all pole joints 306 have slid out to their maximum extended positions, pole 302 has reached its maximum length and may be extended no further. In further exemplary usage of law enforcement aid 300, a user may retract the length of pole 302 by applying an inward longitudinal force along the length of pole 302, thereby pushing or sliding pole joints 306 away from their maximum extended positions and into a nestled position. If pole joints 306 are pushed into a nestled position, pole 302 may retract and the length of pole 302 may decrease. When all pole joints 306 have slid into their minimum nestled positions, pole 302 has reached its minimum length and may be retracted no further.

Portable camera 304 is a component of law enforcement aid 300 that may capture and transmit images. Portable camera 304 may be securely attached to or removed from pole mount 308. Pole mount 308 is a component of law enforcement aid 300 that couples pole 302 to portable camera 304. In an exemplary embodiment of the present invention, pole mount 308 may be located at a proximal end of pole 302. Additionally, pole mount 308 may preferably comprise a universal rail mount connection to couple to portable camera 304. In other embodiments, pole mount 308 may include a male and female screw-type configuration or other type of connection method.

In exemplary usage of law enforcement aid 300, a user may attach portable camera 304 to pole mount 308, extend pole 302 to a desired length and, while holding pole 302, manipulate pole 302 in order to move portable camera 304 to a desired position. In such usage of law enforcement aid 300, pole 302 may be extended in length so that a user may capture and transmit images via portable camera 304 from locations inconvenient, unsafe, or inaccessible to a user not using law enforcement aid 300. Additionally, exemplary usage of law enforcement aid 300 may include where a user may detach portable camera 304 from pole mount 308, and pole 302 may be retracted to its minimum length for convenient storage or transportation of law enforcement aid 300. Thus, law enforcement aid 300, when disassembled, will require less volume for storage and may be easier to transport. Alternatively, to easier transport law enforcement aid 300, a user may attach shoulder sling 316 to carry law enforcement aid 300 over the shoulder.

Rotator 310 and intermediary device 312 are optional components of law enforcement aid 300 that couple pole mount 308 to pole 302. Rotator 310 may be coupled to pole mount 308 and intermediary device 312. Intermediary device 312 may then be coupled to rotator 310 and pole 302. In an exemplary embodiment of the present invention, pole mount 308 may be rotated along a circumferential path, wherein the radius is rotator 310 and center is the connection between rotator 310 and intermediary device 312. Additionally, intermediary device 312 may include a knob or other like component to tighten or release rotator 310 from alignment with respect to intermediary device 312. A user may loosen intermediary device 312, thereby releasing rotator 310 from a position, allowing rotator 310 to be moved along a circumferential path. A user may then tighten intermediary device 312, securely locking rotator 310 into its position. Therefore, in exemplary usage of law enforcement aid 300, portable camera 304 may be more easily pointed in a desired direction, or around a corner or obstacle, by a user holding pole 302, through the manipulation of the angle between pole 302 and pole mount 308 by rotator 310.

Shoulder sling 316 is a component of law enforcement aid 300 that may attach to pole joints 306. Shoulder sling 316 may comprise a strap, sling, band, leash, tie, or other securing mechanism in which a user may secure or hold law enforcement aid 300. In exemplary usage, shoulder sling 316 may be put over a user's shoulder in order to transport law enforcement aid 300. Shoulder sling 316 may be attached to and removed from pole joints 306 by being tied, mechanically attached, snapped, magnetism, or some other method. In an alternative embodiment of the present invention, shoulder sling 316 may be permanently secured to pole joints 306. Furthermore, shoulder sling 316 may be attached to a holster, pouch or other appropriate storage mechanism for carrying portable receiver (not shown) as one unit. Thus, a user is able to conveniently carry law enforcement aid 300 with portable receiver lodged in a holster or carrying pouch for complete transport.

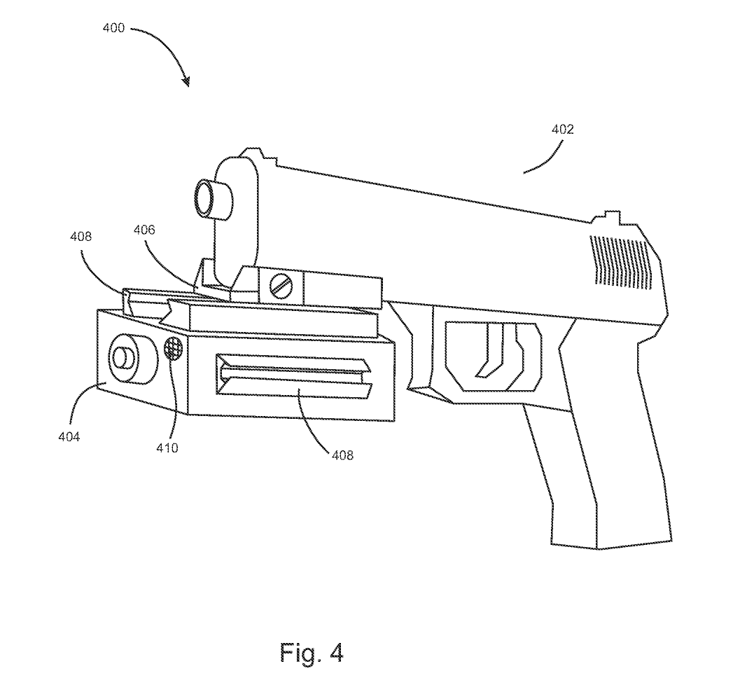

FIG. 4 illustrates a perspective view of an exemplary embodiment of a law enforcement aid. FIG. 4 shows law enforcement aid 400, comprising weapon 402, portable camera 404, weapon mount 406, portable camera connector 408 and audio recording component 410. Law enforcement aid 400 is designed to allow a user to capture and transmit images through portable camera 404, which may be attached or removed from a mount on weapon 402.

Weapon 402 is a component of law enforcement aid 400. While the present embodiment of law enforcement aid 400 may depict weapon 402 comprising a handgun, weapon 402 may comprise a rifle, shotgun, or any type of law enforcement device, firearm, less lethal weapon, taser, or other like device. Weapon mount 406 is a component of law enforcement aid 400 coupled to the exterior housing of weapon 402. Weapon mount 406 is designed to securely couple portable camera connector 408 to weapon 402. Law enforcement aid 400 may include a plurality of weapon mounts 406. In an exemplary embodiment of law enforcement aid 400, weapon mount 406 may comprise a universal rail mount connection to couple to portable camera connector 408. In other embodiments of law enforcement aid 400, however, weapon mount 406 may include a male and female screw-type configuration or other type of connection method.

Portable camera 404 is a component of law enforcement aid 400 that may capture and transmit images. Portable camera 404 may be securely attached to or removed from weapon mount 406 via portable camera connector 408. Portable camera connector 408 is a component portable camera 404 that couples portable camera 404 to weapon 402. In an exemplary embodiment of law enforcement aid 400, portable camera connector 408 may comprise a universal rail mount connection to couple to weapon mount 406. In other embodiments of law enforcement aid 400, however, portable camera connector 408 may include a male and female screw-type configuration or other type of connection method.

In exemplary usage of law enforcement aid 400, a user may attach portable camera 404 to weapon mount 406 such that portable camera 404 captures and transmits images of wherever weapon 402 is aimed as well as audio feedback that is captured by audio recording component 410. Additionally, a user may detach portable camera 404 from weapon 402 when not in use or for portable camera 404 power source recharge, disposal or replacement.

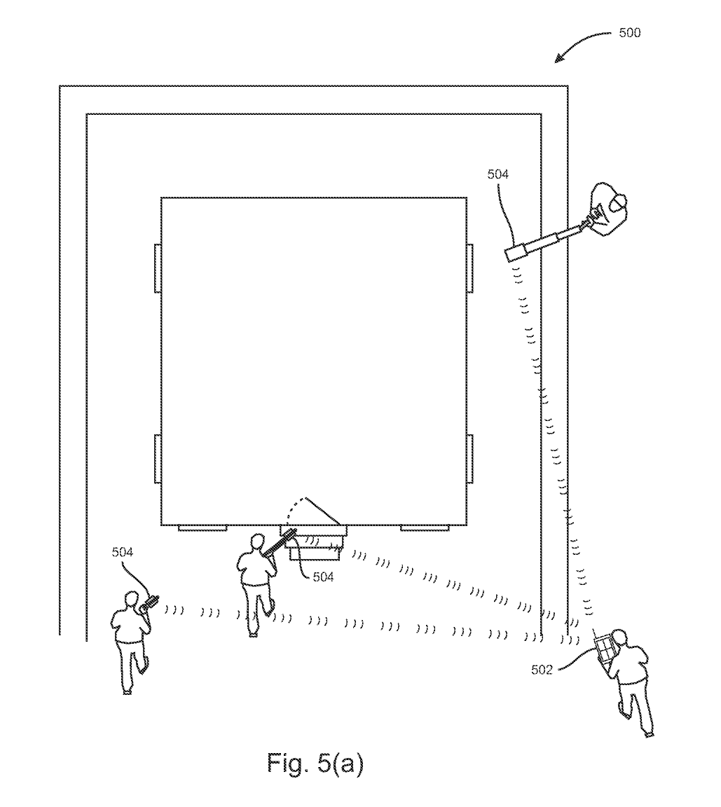

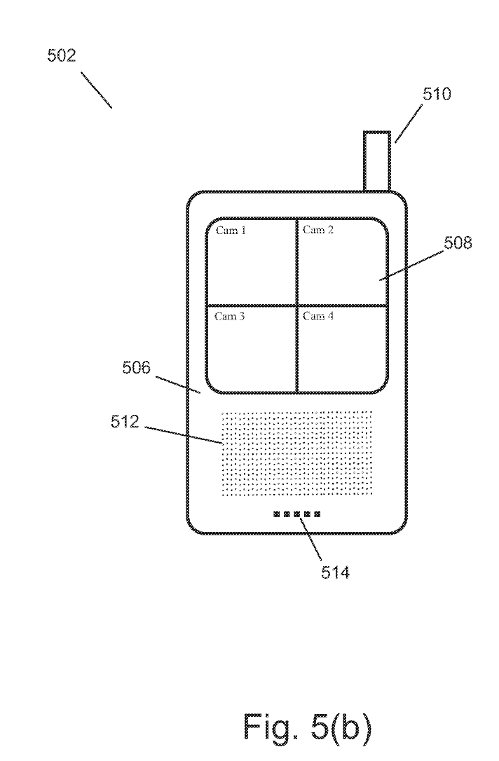

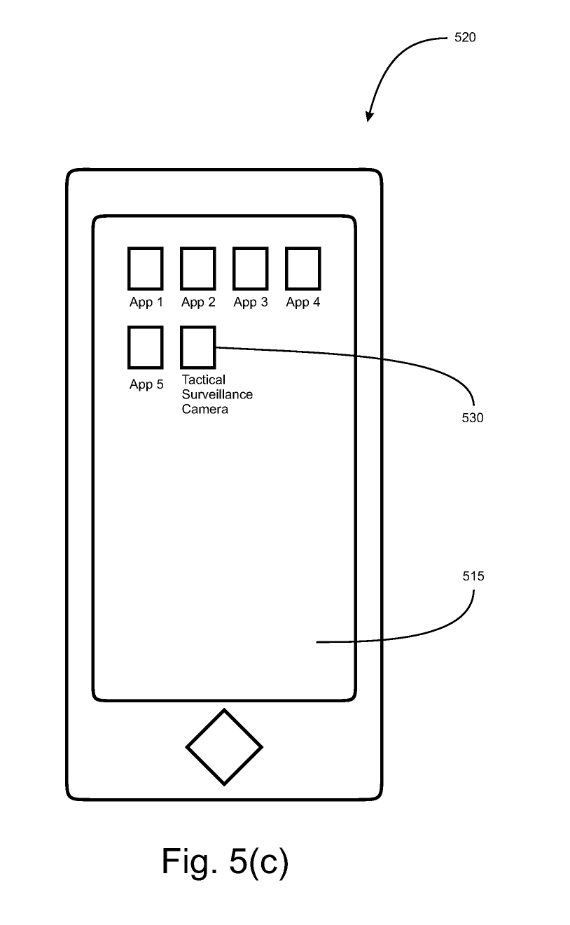

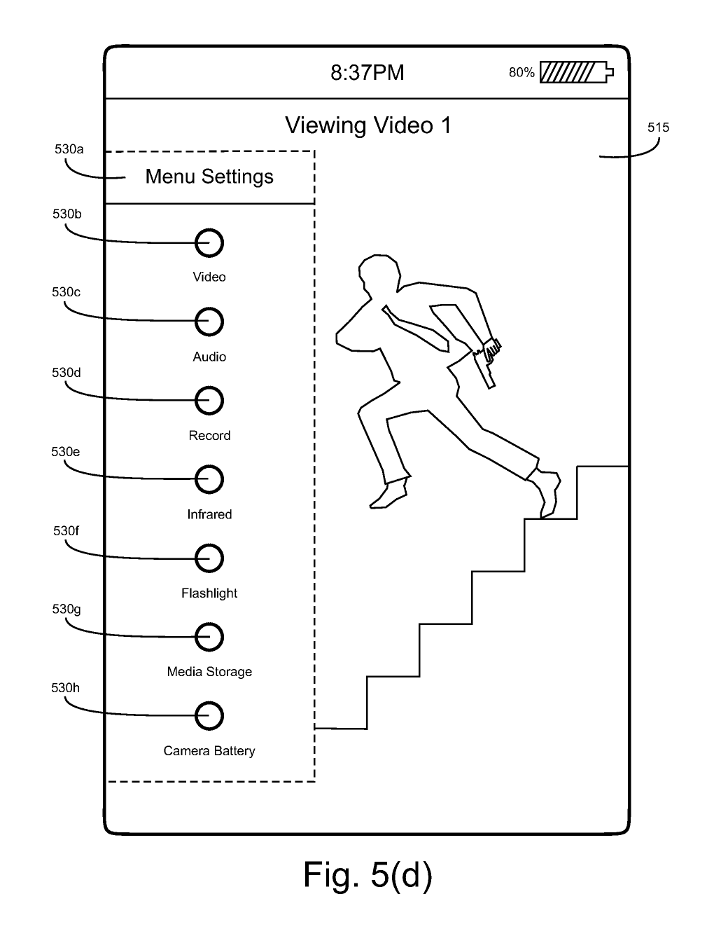

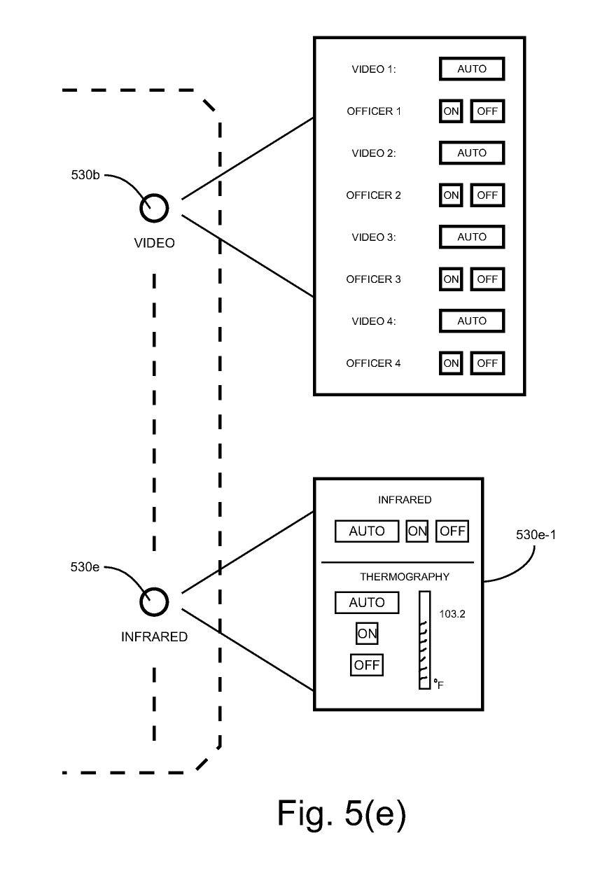

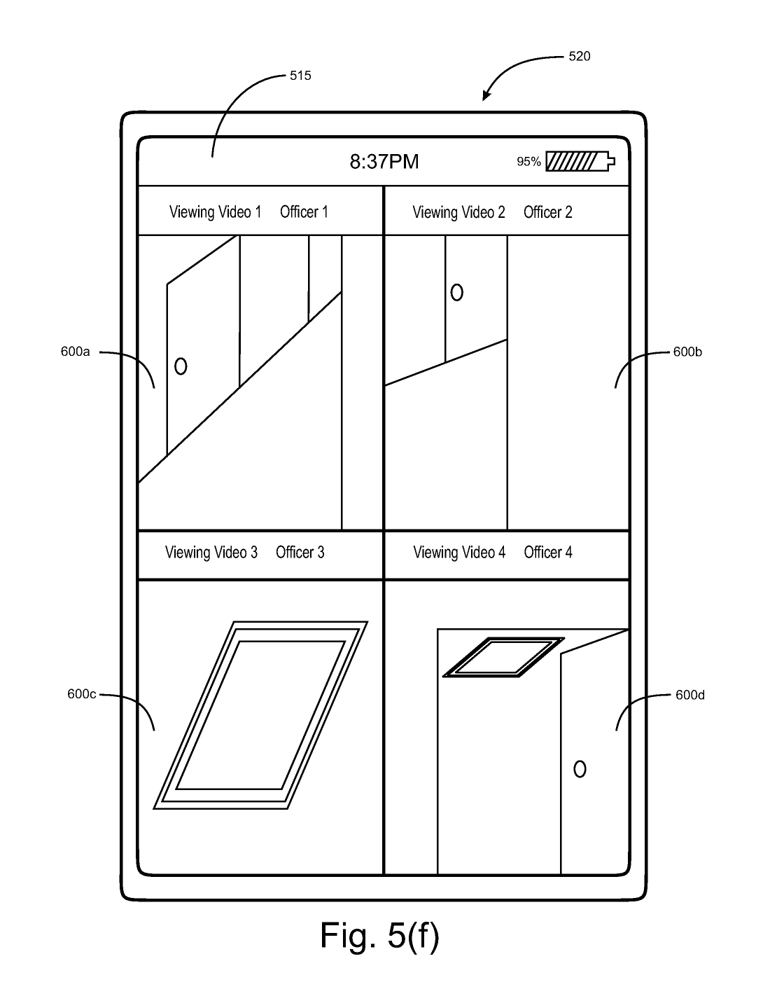

FIG. 5(a) illustrates an overhead view of an exemplary use of a camera surveillance system in accordance with the present invention. In FIG. 5(a), law enforcement officers may utilize a plurality of portable cameras 504 to transmit images to portable receiver 502. FIG. 5(b) illustrates a front elevational view of a portable receiver in a camera surveillance system. FIGS. 5(a) and 5(b) illustrate camera surveillance system 500, which comprises portable receiver 502 and portable cameras 504. Portable receiver 502 comprises receiver housing 506, display 508, antenna 510, audio output 512, and audio input 514. Camera surveillance system 500 is designed to provide a user of portable receiver 502 images from a plurality of portable cameras 504.

Portable receiver 502 is a component of camera surveillance system 500 designed to receive and display images captured and transmitted by portable camera 504. Camera surveillance system 500 may comprise one or more of portable receivers 502. In an exemplary embodiment of the present invention, each portable receiver 502 may receive and display a plurality of images captured and transmitted by a plurality of portable cameras 504. While FIGS. 5(a) and 5(b) illustrate portable receiver 502 capable of receiving and displaying images captured and transmitted by four portable cameras 504, in another embodiment of the present invention, portable receiver 502 may display images received from a single portable camera 504. Therefore, the number of images displayed by portable receiver 502 and the number of portable cameras 504 should not be interpreted so as to limit the scope of the present invention.

In exemplary usage of camera surveillance system 500, each member of a team of law enforcement officers may utilize a portable receiver 502 and a portable camera 504. In such a situation, each law enforcement officer may transmit images they capture with portable camera 504. Additionally, each law enforcement officer may display on portable receiver 502 images received from the portable cameras 504 of other law enforcement officers. In other exemplary usage of camera surveillance system 500, a single portable receiver 502 may be utilized by an officer, who may interpret images received from one or more portable cameras 504.

In alternative embodiments of the present invention, receiver 502 may comprise video and audio storage as well as recording capabilities. In such an embodiment, receiver 502 may comprise a hard drive, flash memory, temporary cache, tape, or some other data storage medium. In usage of such an embodiment, a user may record video for later playback, storage, transmission or analysis, report writing, and criminal and civil prosecution.

Receiver housing 506 is the main body of portable receiver 502. Receiver housing 506 is an object designed to enclose the interior components of portable receiver 502. In an exemplary embodiment of camera surveillance system 500, portable receiver 502 may be lightweight and small such that it may be easily transported and stored by a user, but also to be rigid to maintain a pre-molded shape, and durable and able to withstand the impacts of frequent use. Receiver housing 506 may be composed of a variety of materials, such as metals, plastics, or alloys. This list is not exhaustive, however, and should not be interpreted so as to limit the scope of the present invention. In an exemplary embodiment, housing 102 may be rectangular in shape; however, in other embodiments, housing 102 may be cylindrical, flattened cylindrical, conical, cubical, or another shape configuration or combination thereof.

Display 508 is a component of portable receiver 502 designed to provide a visual representation of images received by antenna 510. In an exemplary embodiment of the present invention, display 508 may be securely enclosed within receiver housing 506, visible to the user. While an exemplary embodiment of the present invention comprises display 508 including a liquid crystal display, the method of display should not be interpreted to limit the scope of the present invention. Display 508 may comprise a liquid crystal display, light emitting diodes, cathode ray tube, liquid crystal on silicon, or other display technology. Additionally, display 508 may include a backlight and provide a visual output in a plurality of colors in the visual spectrum.

Antenna 510 is a component of portable receiver 502 designed to receive images transmitted by portable cameras 504. Antenna 510 may be located within receiver housing 506, or may be external to receiver housing 506. Antenna 510 is connected to display 508 such that display 508 may display images received by antenna 510. In an exemplary embodiment, antenna 510 may receive transmissions on the industrial, scientific, and medical radio (ISM) bands. However, antenna 510 may be configured to receive transmissions on a wide number of other electromagnetic frequencies. Further, antenna 510 may be configured to wirelessly interface directly with a remote device, i.e. Bluetooth protocol, or may be configured to receive images utilizing a wireless network protocol. Additionally, in another embodiment of the present invention, antenna 510 may be adapted to transmit data, command information, or other types of communication in addition to the reception of image transmissions.

Audio output 512 and audio input 514 are optional components of portable receiver 502 that may be designed to provide two-way audio communication to users of camera surveillance system 500. In an exemplary embodiment of the present invention, audio output 512 may comprise a speaker or like device, and audio input 514 may comprise a microphone or like device. In exemplary functionality of the present invention, outgoing audio communication may be audibly inputted through audio input 514 by a user of portable receiver 502 and then transmitted by antenna 510 to other portable receivers 502. Likewise, incoming audio communication may be received by antenna 510 and audibly outputted through audio output 512 to a user of portable receiver 502. Additionally, portable receiver 502 may be configured such that antenna 510 may send and receive audio communication to and from devices other than portable receiver 502, such as cellular phones, two-way radios or other communication devices.

In another embodiment, a user may opt not to use portable receiver 502 with the portable camera 504. As will be explained in further detail below, a user may instead use a wireless mobile device, such as a smartphone device, that has additional interfaces and options for conducting surveillance actions, including a surveillance application software which enable a user with various types of surveillance-related settings (such as infrared). The user's wireless mobile device may be configured to pair with a surveillance device, which includes a combination of portable camera 504 coupled with pole 302 via an ad-hoc peer-to-peer connection. Further details of this embodiment of the present invention are explained with respect to FIGS. 5(c)-(f).

FIG. 5(c) illustrates a user interface 515 of a wireless mobile device depicting the home screen, specifically, a wireless application software's icon for law and military surveillance that may be securely paired with one or more cameras 504.

Instead of using portable receiver 502, in this embodiment, a user may employ a wireless mobile device 520 for use with portable camera 504 coupled with pole 302 via a surveillance application software 530. Wireless mobile device 520 may be any of an iPhone®, iPad®, iTouch®, Galaxy S® or any similarly functioning wireless smartphone device. The application software is designed so that it may be compatible for use with current and future versions of mobile operating systems and other platforms, such as versions Android 4.0 and iOS 5, as well as additional comparable operating systems and platforms. This allows for enhanced compatibility abilities with the various types of wireless mobile devices that may be developed at a later point. These examples are for illustrative purposes and do not limit the scope and breadth of the present invention.

Wireless mobile device 520 may contain a transceiver component (not shown) for sending and receiving data transmissions between device 520 and another device, for example, portable camera 504. Wireless mobile device 520 may also contain a processor component (not shown) for directing all data inputs/outputs, operations and command instructions effectuated by a user on device 520. Device 520 may also contain an audio output component, such as a speaker, commonly found in wireless smartphone devices. These are some of the internal components of wireless mobile device 520, and may contain other internal components, some of which may be further explained or described herein.

Surveillance application software 530 may be downloaded or otherwise installed onto wireless mobile device 520 through any designated website, authorized database or server that may be for law and military personnel or other emergency services personnel. Once a user downloads the application software to his or her wireless mobile device 520, processor generates an icon symbol denoting application software 530 appears on the user interface or touch-screen display 515 of the wireless mobile device 520, which is depicted in FIG. 5(c)'s home screen in this view. In FIG. 5(c), the application software may be illustrated by the icon entitled, “Tactical Surveillance Camera” 530. The name of the application software 530 may vary, and is included herein for illustrative purposes. The user of wireless mobile device 520 can then access, initialize or otherwise actuate the application software 530 icon via the user interface/touch-screen display 515 home screen for the appropriate use (further discussed below).

Upon installation of the application software, the user may access the “Tactical Surveillance Camera” 530 icon to set-up a paired connection between user's wireless mobile device 520 and portable camera 504 coupled with pole 302 (for purposes of simplicity, the combination of the portable camera 504 coupled with pole 302 is hereinafter referred to as camera surveillance device 600).

In the exemplary embodiment, the secure paired connection between wireless mobile device 520 and camera surveillance device 600 is established via an ad-hoc peer-to-peer communication connection. An ad-hoc peer-to-peer connection allows for a user to access and use the wireless mobile device 520 with camera surveillance device 600 without the need for an existing network infrastructure, such as a local area network, the Internet, a hotspot, or other network resource.

An ad-hoc connection also allows for the functionality between wireless device 520 and camera surveillance device 600 in the event the users are in a remote location, such as in a desert region or in a mountainous region. In this case, a remote location may have little to no network infrastructure from which users in the area may rely upon. However, the ad-hoc peer-to-peer connection can allow the users a self-sufficient mode in which to operate their surveillance directly between their devices without the need for an existing network infrastructure. Additionally, this self-sufficient mode allows law or military officers to use devices 520 or 600 without reliance on, for example, a local area network belonging to the suspects or combatants under surveillance.

Further, in an exemplary embodiment, the ad-hoc peer-to-peer connection may be established via an ad-hoc Wi-Fi connection or via an ad-hoc Bluetooth connection. These types of ad-hoc connections may be advantageous for use with camera surveillance device since the particular surveillance actions will typically take place within a shorter distance action range. For example, an ad-hoc Bluetooth connection may be particularly desirable for use with wireless device 520 and camera surveillance device 600 due to its short-range capacities. For purposes of the present description, an action range may be the particular area within which a mission, or other law or military enforcement action is taking place. For example, and without limiting the scope of the present invention, a typical short-distance action range may be anywhere from 10 to 30 feet in distance.

It is desirable for a user to pair wireless mobile device 520 with camera surveillance device 600 once the application software is installed as it also allows for a user-specific functionality when the camera surveillance device 600 is put into use. However, in another embodiment, and as will be discussed later with respect to FIG. 5(f), a user may pair wireless mobile device 520 with more than one camera surveillance devices 600 for purposes of other types of surveillance-specific actions. In another embodiment, a user may pair device 520 with a headset device for visual and/or audio purposes, or alternatively, a user may pair camera surveillance device 600 directly to the headset device. In this embodiment, a headset device may comprise a type of external display device for audio and/or visual purposes, such as earphones or a lens or goggles for receiving visual displays. These devices are some examples of various headset devices that may be used in conjunction with the present invention, and should not be construed as limiting its scope.

Once established, the ad-hoc peer-to-peer connection allows devices 520 and 600 to communicate directly with each other. In an exemplary embodiment, the pairing of devices 520 and 600 is performed through a Bluetooth pairing capability, the method of which may be known to one of ordinary skill in the art. However, other secure pairing methods may be used that include, for example, MAC filtering, encrypted passwords and PIN codes. Further, in the exemplary embodiment, camera surveillance device 600 may contain a Bluetooth interface for facilitating the establishment of the paired connection with wireless mobile device 520 when device 520 is in a discover mode. When wireless mobile device 520 is in a discover mode, it may be set-up to specifically be securely paired with camera surveillance device 600 through a set of steps that are known in the art for pairing two devices to each other.

In one example, when device 520 is in a discover mode, it may detect camera surveillance device 600's Bluetooth interface, entitled “Camera 1(a)” that is available for pairing. The user of device 520 will then proceed through a series of steps in order to link device 520 to device 600's “Camera 1(a),” which may include setting up a customized passkey or PIN code for authentication between the devices. Once the pairing between devices 520 and 600 is established, both devices will continue to automatically recognize each other when in operational use. If, at a later point, the user desires to remove the paired connection between devices 520 and 600, the user may do so by removing, among other steps known in the art, the custom passkey or PIN code previously established. The same or similar method of pairing devices 520 and 600 may be performed with an ad-hoc peer-to-peer Wi-Fi connection.

As previously mentioned, the securely paired Bluetooth connection between wireless mobile device 520 and camera surveillance device 600 may also include encryption means so that user's devices 520 and 600 are secure from others, including potential hackers or other network security threats, particularly during use in the field. Additionally, the use of an ad-hoc peer-to-peer Bluetooth or Wi-Fi connection between devices 520 and 600 generally provides shielding against electronic or electromagnetic interference from existing network infrastructures in the area(s).

FIG. 5(d) illustrates an example of a screen-only view of wireless mobile device 520 depicting live video feed from the camera surveillance device 600 as well as a menu of settings showing a set of exemplary features and functions of the application 530. In this screen-only view of device 520, the user can view live feed transmitted through the ad-hoc peer-to-peer connection with camera surveillance device 600. Viewing of live visual feed on device 520 allows the user to virtually instantaneously see, as well as hear, the actions that are seen and heard by a team of law or military personnel during a mission. This seamlessly occurring live visual and audio feed is important for allowing the law or military personnel to make critical tactical decisions that may lead to a successful mission outcome as well as keep the executing personnel safe.

In FIG. 5(d), at the left-hand side of user interface 515, is a menu of settings 530a, which may be initialized or actuated by the user via touch-screen ability so as to expand menu 530a to list a number of functions and features. In this illustrative view, settings menu 530a appears superimposed over a portion of user interface 515 should user touch a “Menu” button (not shown in this view). Once the “Menu” button is activated by user, the settings menu 530a displays in an extended view listing a number of features and functions, 530b-530i, that may be controlled by user. Should a user initialize or activate any of functions 530b-530i, a request or command for specific data is sent from the transceiver or device 520. Thereafter, the data requested from camera surveillance device 600 may be sent back to device 520 via the transceiver for output to a user. If the user desires to remove the settings menu from its superimposed position in the viewing screen of user interface/touch-screen display 515, the user can simply “swipe” the menu to the left-side of the screen, similar to known touch-screen movements and abilities. In another embodiment, menu 530a may appear on user interface/touch-screen display 515 without the need to open or close it via touch-screen abilities. The settings menu 530a illustrates some of the exemplary features and functions found in the present invention; however, one should not construe this as limiting its scope and breath, and other variations of features and functions that may be included.

Function entitled “video” 530b may be used for initializing or actuating live video feed when camera surveillance device 600 is in operational use via device 520. This may be enabled via an automatic setting, or by setting the live video feed to either “on” or “off” depending on whether the visual feed is needed. Function “audio” 530c may be used for initializing or actuating live audio feed if the user desires to listen to audio sounds for surveillance tactics during an ongoing mission. A user may actuate the “audio” 530c function in which a command is sent to device 600 via device 520's transceiver for audio data. In turn, audio data from device 600 is received at device 520 via its transceiver and an audio output is generated via a speaker component of device 520. This feature may be especially useful depending on the circumstances of the particular mission at stake. Similar to the “video” 530b setting, a user may enable “audio” 530c through an “automatic” setting, or by setting the live audio feed to either “on” or “off.”

Function “record” 530d enables a user to initialize or actuate the recording of visual and/or audio feed during a law or military type surveillance mission via device 520. The settings for the “record” 530d feature may have similar settings as features 530b and 530c, i.e., “automatic,” “on,” and “off.” The “record” 530d feature allows law or military personnel to record surveillance actions as they are occurring for future reference and review purposes. The recordings performed with the “record” 530d feature may include the option of saving the recordings in video and/or audio files that may be known in the art and that are compatible with wireless mobile device 520. For example, and without limiting the scope of the present invention, video and/or audio files may be saved in any of QuickTime, MP3, or other compatible media file for use on wireless mobile device 520. In one embodiment, the “record” 530d feature allows the user the option of recording a separate audio file in addition to the video (including audio) feed. The discussion of feature “record” 530d is one manner of carrying out the present invention, and should not be construed as limiting the scope of the present invention.

Another function, “infrared” 530c provides the user the option of initializing or actuating infrared, thermal as well as thermography techniques while viewing live visual feed from camera surveillance device 600. This may enable the user with such capabilities as “night vision” visual feed from device 600 as well as the ability to see in various types of weather conditions, such as rain and fog. Some infrared techniques that may be enabled within the “infrared” 530e feature, for example, are those which allow a user to see at longer distances in complete darkness. Other current and developing infrared and thermography techniques may be included or otherwise incorporated into the “infrared” 530e feature to assist in the user's surveillance abilities and techniques.

Additionally, one of the thermography techniques that may be incorporated into the “infrared” 530e feature is the ability to interpret and measure the temperature(s) of the infrared and thermal images seen through the live visual feed from device 600. As shown in FIG. 5(e), a thermometer image may be included in the “infrared” 530e settings showing the various temperatures detected by the infrared/thermal imaging.

These infrared and thermography features may be critical in allowing a user to conduct the appropriate surveillance at any time of the day and in a variety of weather conditions and other harsh or stressful conditions. For example, the infrared/thermal features may allow a user to conduct surveillance and detect suspects in an area that was recently bombed and covered in heavy debris and dust materials. The infrared imaging techniques allow the user the advantage of having the ability for enhanced high-level type surveillance. The discussion of feature “infrared” 530e is one manner of carrying out the present invention, and should not be construed as limiting the scope of the present invention.

Function “flashlight” 530f allows a user to initialize or actuate a light source located at camera surveillance device 600 during surveillance via device 520. The light source of camera surveillance device 600 allows for additional light in certain types of surveillance situations in which a user may need more acute-viewing visual feed. The “flashlight” 530f feature may allow for various light brightness settings depending on the user's preferences and needs during surveillance. For example, during a search for a suspect, a user may need to enter a dark basement area. In this example, no light source in the basement is available for use. As a result, user can employ the “flashlight” 530f feature to illuminate the surrounding area that is being viewed with camera surveillance device 600 for further tactical and surveillance purposes. The discussion of feature “flashlight” 530f is one manner of carrying out the present invention, and should not be construed as limiting the scope of the present invention.

Function “media storage” 530g enables a user to initialize or actuate the saving of video and audio format files to a database in wireless mobile device 520 for further reference and use. Similar to the functions described above, a user may actuate function 530g to facilitate saving a media file of recorded video and/or audio data in a database via the processor of device 520. As indicated above with respect to the “record” 530d feature, the video and audio files may be saved in any of QuickTime, MP3, or other compatible media file for use on wireless mobile device 520. During a law enforcement mission, a user may be required to record the active surveillance actions taken during the mission. In the mission, the user will use the “record” 530d feature during the entire length of the mission. Once the mission in complete, user can access the unnamed video file of the recorded mission and save the video file with a particular name and/or date. The saved video file can then be transferred to the electronic devices/systems of other law enforcement personnel by methods known in the art for further review and analysis of the missions. The discussion of feature “media storage” 530g is one manner of carrying out the present invention, and should not be construed as limiting the scope of the present invention.

Function “camera battery” 530h allows a user to monitor the remaining battery capacity of camera 504 component of camera surveillance device 600. A user may initialize or actuate “camera battery” 530h to request data regarding the state of a battery power charge from device 600 via the transceiver of device 520. Thereafter, the user may receive the data related to the state of the battery power charge via device 520's transceiver. By monitoring the remaining battery capacity of camera 504, a user can prevent the instance of the battery capacity being low or non-existent during the course of an active mission. Camera 504 of camera surveillance device 600 may incorporate one or more removable battery units to power it, such as 3V batteries, so as to alleviate the need for continually recharging a rechargeable battery unit or reliance upon an established power source. Since function “camera battery” 530h allows for a user to monitor the capacity of the batteries used to power camera 504, a user can ensure that the camera surveillance device 600 is currently powered and working consistently during each surveillance mission.

Further, the use of one or more removable batteries in camera 504 allows for easily replacing one or more of the removable batteries with new batteries in the event the battery capacity is low or non-existent. The use of removable batteries in camera 504 also allows user to maintain a self-sufficient surveillance system in place regardless of the location of the mission. The discussion of function “camera battery” 530h is one manner of carrying out the present invention, and should not be construed as limiting the scope of the present invention.

FIG. 5(e) illustrates an exploded-view of the internal settings for certain of the application features and functions previously illustrated and discussed with respect to FIG. 5(d). At the top of FIG. 5(e) is the “video” 530b feature button, previously explained above in the FIG. 5(d) discussion. In the event a user taps or otherwise touches the “video” 530b button, an expanded “video” menu 530b-1 may appear which further depicts the internal features and settings for “video” 530b.

In one embodiment of the present invention, “video” menu 530b-1 may depict four already existing pairings of wireless mobile device 520 with four separate camera surveillance devices 600. Video menu 530b-1 may list each of the four camera surveillance devices 600 by name of each user. In this embodiment, video menu 530b-1 shows “Video 1” paired with a camera surveillance device 600 belonging to “Officer 1,”; “Video 2” is paired to a camera surveillance device 600 belonging to “Officer 2”; “Video 3” is paired to a camera surveillance device 600 belonging to “Officer 3”; and “Video 4” is paired to a camera surveillance device 600 belonging to “Officer 4.” In this embodiment, the user of wireless mobile device 520 has the option of setting each Video Nos. 1-4 to an “automatic,” “on,” or “off” status. If, for example, “Video 1” is set to an “automatic” setting, wireless mobile device 520 can detect and enable live video feed from “Video 1” whenever Officer 1's camera surveillance device 600 is on and in operation. The same option may apply to Video Nos. 2-4 depending on the user's preferences and requirements during surveillance. The discussion of this embodiment of the “video” menu 530b-1 is one manner of carrying out the present invention, and should not be construed as limiting the scope of the present invention.

Also depicted in FIG. 5(e) is the “infrared” 530e function previously discussed with respect to FIG. 5(d). In one embodiment, if a user were to initiate or touch the “infrared” 530e function on the touch-screen user interface of wireless mobile device 520, an expanded “infrared” menu 530e-1 may appear which further depicts the internal features and settings for “infrared” 530e. Further, in the embodiment depicted in FIG. 5(e), the “infrared” menu 530e-1 may include such features as “auto,” “on,” and “off.”

Additionally, “infrared” menu 530e-1 may also include other functions related to thermographic information, such as temperature readings for the infrared/thermal images generated through these settings for the live visual feed. In one embodiment, “infrared” menu 530e-1 may include a temperature bar illustration to indicate the range of temperatures read from the infrared/thermal imaging generated from the live visual feed. The discussion of this embodiment of the “infrared” menu 530e-1 is one manner of carrying out the present invention, and should not be construed as limiting the scope of the present invention.

FIG. 5(f) illustrates an example of a live video feed as seen on the user interface viewing screen and specifically, depicts a multi-video viewing mode of four camera surveillance devices 600 that may be paired to wireless mobile device 520. As indicated above with respect to “video” menu 530b-1 in FIG. 5(e), a user may pair wireless mobile device 520 to one or more camera surveillance devices 600. This particular set-up may be required or convenient for a team leader of an assigned surveillance group to monitor his team members during a mission and direct them accordingly. In this embodiment, user's wireless mobile device 520 is paired to four separate camera surveillance devices 600 belonging to users “Officer 1,” “Officer 2,” “Officer 3,” and “Officer 4.”

In this embodiment of the present invention set out in FIG. 5(f), the following sequence of events may unfold during a particular law enforcement mission. A team of five law enforcement officers are called upon to search for one or more suspects/combatants in a building. The law enforcement entry team includes four officers (Officers 1-4) each equipped with a camera surveillance device 600 and Officer 5 who is a team leader (Team Leader) of the entry team and is equipped with wireless mobile device 520. In this particular scenario, Team Leader's wireless mobile device 520 has already been secured paired with each camera surveillance device 600 of each of the four officers via an ad-hoc peer-to-peer Bluetooth (or WiFi) connection.

The entry team proceeds to enter the building where the suspects or combatants are reported to be located. Officers 1 and 2 are directed to move left down one corridor of the building to scan and clear the corridor. Officers 3 and 4 are directed to search and clear a room adjoining the corridor. As Officers 1-4 are searching the corridor and adjoining room, respectively, with each camera surveillance device 600, Team Leader is able to assess what each of Officers 1-4 are viewing on wireless mobile device 520, which depicts four separate screens of the live video feed transmitted from Officers 1-4's camera surveillance devices 600. In FIG. 5(f), the live video feed that is simultaneously displayed in each of the four smaller screens is labeled 600a, 600b, 600c and 600d.

At this point, Team Leader views the video feed being transmitted from the camera surveillance devices 600 of each Officers 1 and 2 in screens 600a and 600b, and further determines that Officers 1 and 2 require additional assistance since additional rooms have been located in the corridor. An additional two stand-by officers, Trailers 1 and 2, are instructed to enter the building and assist Officers 1 and 2 with clearing the additional rooms located in the corridor area.

Subsequently, Team Leader is notified by Officers 3 and 4 that there is an attic hatch in the adjoining room, and is also able to search the attic hatch in screen 600c transmitted from the camera surveillance device 600 of Officer 3. Team Leader then instructs Officer 4 to cover high for Officer 3 who is then instructed to use camera surveillance device 600 to view the attic area for the suspects/combatants. Prior to the beginning of the mission, Team Leader had previously adjusted the settings for each of Officers 1-4 “infrared” 530e settings by utilizing “infrared” menu 530e-1 to set each of the infrared settings to an “automatic” status. In this case, once Officer 3 positions camera surveillance device 600 to enter and view the attic area, it automatically switches to an infrared setting in order to compensate for the dark attic area and allow proper viewing of the surrounding area. A 360 degree viewing is completed by rotating camera surveillance device 600 accordingly, and no suspects or combatants are located in the attic area.

Officers 1-5 now exit the rear of the building structure, and notice that the building rests upon a raised foundation as well as notice that there is a disturbed access panel at the base of the building foundation. Team Leader instructs Officer 2 to provide cover to Officer 1 as Officer 1 laterally positions his camera surveillance device 600 into the access area at the base of the building's foundation. At this point, Team Leader is able to view a suspect in hiding on screen 600a and immediately enables the “record” 530d button. The suspect is given the appropriate commands to surrender himself. However, the suspect initially refuses to surrender and proceeds to make a number of incriminating statements, which are being recorded by Team Leader on wireless mobile device 520.

A portable camera and surveillance device has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A smartphone device, comprising:
a transceiver;
a touch-screen display; and
a processor configured to:
generate an icon on the touch-screen display;
in response to a user initiation on the touch-screen display associated with the icon, provide on the touch-screen display a plurality of icons representing functions;
in response to the user actuation of a first function of the plurality of functions, sending a command to a paired camera via the transceiver requesting video data from the paired camera and recover video data from the paired camera via the transceiver; and
generate an image on the touch-screen display based on the video data.

2. The device of claim 1, wherein in response to a user actuation of a second function of the plurality of functions, sending a command to the paired camera via the transceiver requesting audio data from the paired camera and recover audio data from the paired camera via the transceiver; and generate an audio output via a speaker output of the smartphone device.

3. The device of claim 1, wherein in response to a user actuation of a third function of the plurality of functions, sending a command to the paired camera via the transceiver requesting recorded video and audio data from the paired camera and recover recorded video and audio data from the paired camera via the transceiver, and generate a media file of the recorded video and audio data.

4. The device of claim 1, wherein in response to a user actuation of a fourth function of the plurality of functions, sending a command to the paired camera via the transceiver requesting infrared video data from the paired camera and recover infrared video data from the paired camera via the transceiver, and generate an infrared image on the touch-screen display based on the infrared video data.

5. The device of claim 1, wherein in response to a user actuation of a fifth function of the plurality of functions, sending a command to the paired camera via the transceiver requesting video data from the paired camera with the enablement of a light source of the paired camera and recover video data with the enablement of a light source on the paired camera from the paired camera via the transceiver, and generate an image on the touch-screen display based on the video data with the enablement of a light source.

6. The device of claim 1, wherein in response to a user actuation of a sixth function of the plurality of functions, sending a command to the paired camera via the transceiver requesting a state of a battery power charge and recover data related to the state of the battery power charge via the transceiver, and generate an image on the touch-screen display based on the data related to the state of the battery power charge.

7. The device of claim 3, wherein in response to a user actuation of a seventh function, sending a command to the processor to save the media file of the recorded video and audio data in a database.

8. The device of claim 1, wherein the paired camera is coupled to a pole via an intermediary device coupled to support the paired camera and pivotally coupled to the pole in a manner to adjust an angle between a viewing axis of the paired camera and a longitudinal axis of the pole from substantially zero degrees to substantially ninety degrees.

9. A smartphone device, comprising:
a first transceiver;
a touch-screen display;
a processor; and
an external paired display device, which further comprises a second transceiver;
wherein the processor is configured to:
generate an icon on the touch-screen display;
in response to a user initiation on the touch-screen display associated with the icon, provide on the touch-screen display a plurality of icons representing functions;
in response to the user actuation of a first function of the plurality of functions, send a command to a paired camera via the first transceiver requesting video data from the paired camera;
in response to the command requesting video data, the paired camera sends video data via the second transceiver and generates an image on the externally paired display device based on the video data.

10. The device of claim 9, wherein in response to a user actuation of a second function of the plurality of functions, sending a command to the paired camera via the first transceiver requesting audio data from the paired camera and recover audio data from the paired camera via the second transceiver; and generate an audio output via a speaker output of the externally paired display device.

11. The device of claim 9, wherein in response to a user actuation of a third function of the plurality of functions, sending a command to the paired camera via the first transceiver requesting recorded video and audio data from the paired camera and recover recorded video and audio data from the paired camera via the second transceiver, and generate a media file of the recorded video and audio data.

12. The device of claim 9, wherein in response to a user actuation of a fourth function of the plurality of functions, sending a command to the paired camera via the first transceiver requesting infrared video data from the paired camera and recover infrared video data from the paired camera via the second transceiver, and generate an infrared image on the externally paired display device based on the infrared video data.

13. The device of claim 9, wherein in response to a user actuation of a fifth function of the plurality of functions, sending a command to the paired camera via the first transceiver requesting video data from the paired camera with the enablement of a light source of the paired camera and recover video data with the enablement of a light source on the paired camera from the paired camera via the second transceiver, and generate an image on the externally paired display device based on the video data with the enablement of a light source.

14. The device of claim 9, wherein in response to a user actuation of a sixth function of the plurality of functions, sending a command to the paired camera via the first transceiver requesting a state of a battery power charge and recover data related to the state of the battery power charge via the second transceiver, and generate an image on the externally paired display device based on the data related to the state of the battery power charge.

15. The device of claim 11, wherein in response to a user actuation of a seventh function, sending a command to the processor to save the media file of the recorded video and audio data in a database.

16. A smartphone device, comprising:
a transceiver;
a touch-screen display; and
a processor configured to:
generate an icon on the touch-screen display;
in response to a user initiation on the touch-screen display associated with the icon, provide on the touch-screen display a plurality of icons representing functions;
in response to the user actuation of a first function of the plurality of functions, send a command to a plurality of paired cameras via the transceiver requesting video data from the plurality of paired cameras and recover video data from the plurality of paired cameras via the transceiver; and
generate one or more images on the touch-screen display based on the video data from the plurality of paired cameras.

17. The device of claim 16, wherein in response to a user actuation of a second function of the plurality of functions, sending a command to the plurality of paired cameras via the transceiver requesting audio data from the paired camera and recover audio data from the plurality of paired cameras via the transceiver; and generate an audio output via a speaker output of the smartphone device.

18. The device of claim 16, wherein in response to a user actuation of a third function of the plurality of functions, sending a command to the plurality of paired cameras via the transceiver requesting recorded video and audio data from the plurality of paired cameras and recover recorded video and audio data from the plurality of paired cameras via the transceiver, and generate a media file of the recorded video and audio data.

19. The device of claim 16, wherein in response to a user actuation of a fourth function of the plurality of functions, sending a command to the plurality of paired cameras via the transceiver requesting infrared video data from the plurality of paired cameras and recover infrared video data from the plurality of paired cameras via the transceiver, and generate an infrared image on the touch-screen display based on the infrared video data.

20. The device of claim 16, wherein in response to a user actuation of a fifth function of the plurality of functions, sending a command to the plurality of paired cameras via the transceiver requesting video data from the plurality of paired cameras with the enablement of a light source of the plurality of paired cameras and recover video data with the enablement of a light source on the plurality of paired cameras from the plurality of paired cameras via the transceiver, and generate an image on the touch-screen display based on the video data with the enablement of a light source.
